(19) United States
(12) Patent Application Publication
(10) Pub. No.: US 2024/0203672 A1
(43) Pub. Date: Jun. 20, 2024

(54) SWITCH DEVICE

(71) Applicant: NITTO DENKO CORPORATION, Osaka (JP)

(72) Inventors: Takeshi MURASHIGE, Osaka (JP); Takafumi HINO, Osaka (JP); Atsushi KISHI, Osaka (JP)

(73) Assignee: NITTO DENKO CORPORATION, Osaka (JP)

(21) Appl. No.: 18/287,099

(22) PCT Filed: Apr. 18, 2022
(86) PCT No.: PCT/JP2022/018058

§ 371 Date: Oct. 16, 2023

(30) Foreign Application Priority Data
Apr. 21, 2021 (JP) 2021-071711

(51) Int. Cl. H01H 13/20; H01H 13/04; H01H 13/14

(52) U.S. Cl. CPC H01H 13/20; H01H 13/04; H01H 13/14

(57) ABSTRACT

A present switch device includes a glass layer, and a switch section situated on a back surface side of the glass layer. A thickness of the glass layer is 20 μm or greater and 150 μm or less. The switch section includes a plurality of contact points including a vertically movable contact point. When the glass layer is pushed, the glass layer elastically deforms and the plurality of contact points switch between a continuous state and a non-continuous state.

### TECHNICAL FIELD

The present invention relates to a switch device.

### BACKGROUND ART

Switches configured to mechanically control electrical contact are often used as an input method of electronic parts. For example, a tactile switch described in Patent Document 1 is an example of such a switch. Among these types of switches, sliding-type buttons can recognize ON or OFF by themselves and are considered to have a good feature that they do not incur as many erroneous operations as do touch-type ones.

Among these types of switches, switches that have vertically movable contact points and slide vertically have an outermost surface that is formed of a resin that is flexible and does not easily break. However, resin surfaces easily deteriorate by, for example, scratching, are difficult to wash with, for example, solvents, and do not have a good texture. Hence, a switch device that overcomes these problems is demanded.

### CITATION LIST

### Patent Document

Patent Document 1: Japanese Unexamined Patent Application Publication No. 06-203679

### SUMMARY OF INVENTION

### Problem to be Solved by Invention

The present invention was made in view of the point described above, and an object of the present invention is to improve scratch resistance, solvent washability, and texture of a switch device that includes a vertically movable contact point.

### Means for Solving Problem

A switch device includes a glass layer and a switch section situated on a back surface side of the glass layer. A thickness of the glass layer is 20 μm or greater and 150 μm or less. The switch section includes a plurality of contact points including a vertically movable contact point. When the glass layer is pushed, the glass layer elastically deforms and the plurality of contact points switch between a continuous state and a non-continuous state.

### Advantageous Effects of Invention

The disclosed technique can improve scratch resistance, solvent washability, and texture of a switch device that includes a vertically movable contact point.

### BRIEF DESCRIPTION OF DRAWINGS

FIG. 1 is a cross-sectional view (part 1) illustrating a switch device according to a first embodiment.

FIG. 2 is a cross-sectional view (part 2) illustrating the switch device according to the first embodiment.

FIG. 3 is a cross-sectional view (part 3) illustrating the switch device according to the first embodiment.

FIG. 4 is a cross-sectional view (part 4) illustrating the switch device according to the first embodiment.

FIG. 5 is a cross-sectional view (part 5) illustrating the switch device according to the first embodiment.

FIG. 6 is a cross-sectional view (part 6) illustrating the switch device according to the first embodiment.

FIG. 7 is a cross-sectional view (part 7) illustrating the switch device according to the first embodiment.

FIG. 8 is a cross-sectional view (part 8) illustrating the switch device according to the first embodiment.

### DESCRIPTION OF EMBODIMENTS

An embodiment for carrying out the invention will be described below with reference to the drawings. The same components may be denoted by the same reference numerals in the drawings, and repetitive descriptions of such components may be omitted.

### Overview of First Embodiment

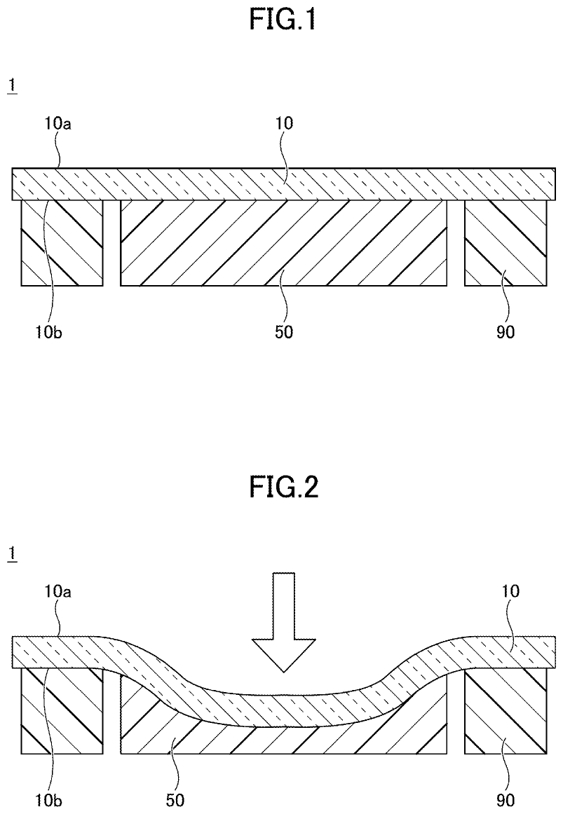

FIG. 1 is a cross-sectional view (part 1) illustrating a switch device according to a first embodiment. As illustrated in FIG. 1, a switch device 1 includes a glass layer 10, a switch section 50, and a support section 90. The switch device 1 is packaged on, for example, a wiring board.

One surface 10a of the glass layer 10 is the outermost surface of the switch device 1. The switch section 50 is situated at the other surface 10b side (back surface side) of the glass layer 10. The switch section 50, although illustrated exemplarily in FIG. 1, is a sliding-type switch, and includes a plurality of contact points including a vertically movable contact point. The switch section 50 may include two, or three or more contact points.

The support section 90 is situated at the other surface 10b side of the glass layer 10, and supports the glass layer 10. The support section 90 may be situated on the outer side of the switch section 50 in a frame shape to enclose the switch section 50. Alternatively, a plurality of support sections 90 may be situated at intervals at desirably selected positions that are on the outer side of the switch section 50. The support section 90 is made of, for example, a resin or a metal.

A part that constitutes the switch section 50 may be used as the support section. Alternatively, the switch section 50 itself may be used as a support section. That is, the support section may be a part or the entirety of the switch section 50. In such cases, the support section 90 illustrated in FIG. 1 need not be provided. Alternatively, a part or the entirety of the switch section 50 may be used as a support section, and the support section 90 illustrated in FIG. 1 may further be provided separately.

FIG. 2 is a cross-sectional view (part 2) illustrating the switch device according to the first embodiment, and illustrates a state in which the one surface 10a of the glass layer 10 is pushed in the arrow direction.

The thickness of the glass layer 10 is 20 μm or greater and 150 μm or less. When the glass layer 10 has such a thickness, the glass layer 10 can elastically deform and dent locally. When the one surface 10a of the glass layer 10 is pushed, the glass layer 10 elastically deforms, to slide the contact points of the switch section 50 in the vertical direction. Hence, the plurality of contact points of the switch section 50 switch between a continuous state and a non-continuous state. For example, the glass layer 10 can elastically deform as if it sank in a perpendicular direction by approximately from 0.5 mm through 2 mm.

For example, when the contact points of the switch section 50 are in a non-contacting state (non-continuous state) when the glass layer 10 is not pushed, pushing and deforming the glass layer 10 makes the contact points of the switch section 50 contact and become a continuous state with each other. When the pushing force in the arrow direction is removed in FIG. 2, the glass layer 10 returns to the state of FIG. 1, and the two contact points of the switch section 50 become a non-contacting state again.

Hence, by providing the glass layer 10 with a thickness of 20 μm or greater and 150 μm or less, it is possible to make the glass layer 10 elastically deformable. Hence, pushing the glass layer 10 is accompanied by local deformation of the glass layer 10, which hence can slide the contact points of the switch section 50 vertically, and can switch between a continuous state and a non-continuous state of the plurality of contact points of the switch section 50.

Because the switch device 1 has the glass layer 10 on the outermost surface, its scratch resistance, solvent washability, and texture can be improved better than when the outermost surface is made of a resin. Moreover, because the switch device 1 is a sliding-type switch, it can give a pushing feel and can reduce the risk of occurrence of erroneous operations.

As a switch that uses glass on the outermost surface, a type that uses, for example, capacitance is conceivable. However, it is difficult for typical plate glass to create vertically sliding operations. Hence, a pushing feel cannot be obtained, and an unintentional touch may cause an erroneous operation.

### First Example of the First Embodiment

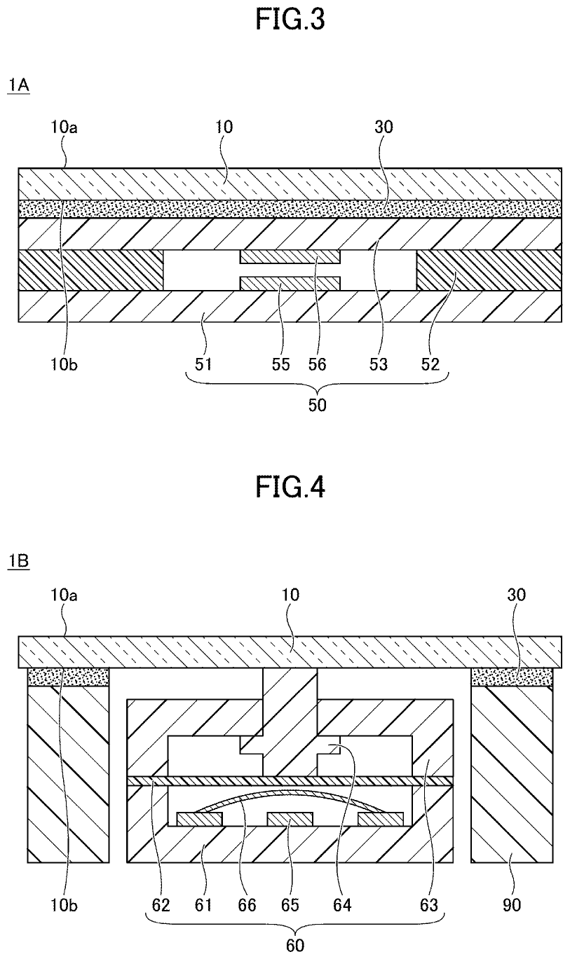

FIG. 3 is a cross-sectional view (part 3) illustrating the switch device according to the first embodiment, and illustrates a specific first example of the configuration of the switch device. As illustrated in FIG. 3, a switch device 1A includes a glass layer 10, a junction layer 30, and a switch section 50.

In the switch device 1A, the thickness of the glass layer 10 is 20 μm or greater and 150 μm or less. The switch section 50 is situated on an other surface 10b side of the glass layer 10. The junction layer 30 that joins the glass layer 10 and the switch section 50 to each other is interposed at the other surface 10b side of the glass layer 10. In the switch device 1A, the switch section 50 also functions as a support section.

The switch section 50 is a membrane switch, and includes a first sheet 51, a spacer 52, a second sheet 53, a first contact point 55, and a second contact point 56. The first sheet 51 and the second sheet 53 are situated oppositely to each other with the spacer 52 interposed therebetween. For example, the spacer 52 is situated to contact the circumferential portion of the upper surface of the first sheet 51 and the circumferential portion of the lower surface of the second sheet 53, and the inward portion of the spacer 52 is hollow. The first contact point 55 is situated on the first sheet 51 on a side facing the second sheet 53, and the second contact point 56 is situated on the second sheet 53 on a side facing the first sheet 51 separately from the first contact point 55. The second sheet 53 is elastically deformable. The first sheet 51, the spacer 52, and the second sheet 53 are made of, for example, a resin.

In the switch device 1A illustrated in FIG. 3, when one surface 10a of the glass layer 10 is pushed as in the case of FIG. 2, the glass layer 10 elastically deforms, and the first contact point 55 and the second contact point 56 of the switch section 50 switch between a contacting state and a non-contacting state. FIG. 3 does not illustrate an external connection terminal to be electrically connected to the first contact point 55 and the second contact point 56.

In the example of FIG. 3, the first contact point 55 and the second contact point 56 of the switch section 50 are in a non-contacting state (non-continuous state) when the glass layer 10 is not pushed. Hence, when the glass layer 10 is pushed and deformed, the second sheet 53 of the switch section 50 elastically deforms along with this to bring the second contact point 56 close to the first contact point 55, and the first contact point 55 and the second contact point 56 contact each other and enter a continuous state. As in the case of FIG. 2, when the pushing force on the glass layer 10 is removed, the glass layer 10 returns to the state of FIG. 3, and the first contact point 55 and the second contact point 56 become a non-contacting state again.

Here, the glass layer 10 and the junction layer 30 will be described in more detail.

The glass layer 10 is not particularly limited, and an appropriate glass layer may be employed in accordance with the intended purpose. According to classification by composition, examples of the glass layer 10 include soda-lime glass, borate glass, aluminosilicate glass, and quartz glass. According to classification by alkali component, examples of the glass layer 10 include non-alkali glass, and low alkali glass. The content of an alkaline metal component (e.g., Na₂O, K₂O, and Li₂O) in the glass is preferably 15% by weight or less and more preferably 10% by weight or less.

The thickness of the glass layer 10 is preferably 20 μm or greater in view of the surface hardness, airtightness, and corrosion resistance of the glass. Moreover, because the glass layer 10 needs to have flexibility and repetition durability like those of a film, the thickness of the glass layer 10 is preferably 150 μm or less. The thickness of the glass layer 10 is yet more preferably 30 μm or greater and 120 μm or less, and particularly preferably 50 μm or greater and 100 μm or less.

The transmittance of light having a wavelength of 550 nm through the glass layer 10 is preferably 85% or higher. The refractive index of the glass layer 10 for a wavelength of 550 nm is preferably from 1.4 through 1.65. The density of the glass layer 10 is preferably from 2.3 g/cm³ through 3.0 g/cm³, and more preferably from 2.3 g/cm³ through 2.7 g/cm³.

The method for molding the glass layer 10 is not particularly limited, and an appropriate method may be employed in accordance with the intended purpose. Representatively, it is possible to produce the glass layer 10 by melting a mixture containing a main raw material such as silica and alumina, a defoaming agent such as mirabilite and antimony oxide, and a reductant such as carbon at a temperature of approximately from 1,400° C. through 1,600° C., molding the resulting product into a thin plate shape, and subsequently cooling the resulting product. Examples of the method for molding the glass layer 10 include a slot downdraw method, a fusion method, a float method. Optionally, the glass layer molded into a plate shape by any such method may be, as needed, chemically polished with a solvent such as hydrofluoric acid in order to be made thin and have an improved smoothness.

A functional layer such as an antifouling layer, an antireflection layer, a conductive layer, a reflective layer, and a decorative layer may be provided on either or both of the external surface and the back surface of the glass layer 10. In the switch device according to the present embodiment, the glass layer 10 is positioned on the outermost surface. Here, “the glass layer 10 being positioned on the outermost surface” means the glass layer 10 being positioned substantially on the outermost surface. Even when such an additional layer as described above is provided, the glass layer 10 is expressed as being positioned on the outermost surface in the present embodiment.

As the junction layer 30, a desirably selected tackifier or adhesive may be used. However, in terms of strength, it is preferable to use an adhesive as the junction layer 30. The thickness of the junction layer 30 is preferably 0.5 μm or greater and 25 μm or less, more preferably 0.5 μm or greater and 5 μm or less, and yet more preferably 0.5 μm or greater and 3 μm or less in terms of appearance.

In the present specification, a tackifier means a layer that has adhesiveness at normal temperature and adheres to an adhering target at a low pressure. Hence, even when the adhering target pasted on the tackifier is peeled, the tackifier maintains a practical tackifying force. On the other hand, an adhesive means a layer that can bond substances by being interposed between the substances. Hence, when an adhering target pasted on the adhesive is peeled, the adhesive has no practical adhesive force.

When using a tackifier as the junction layer 30, a tackifier in which, for example, an acrylic-based polymer, a silicone-based polymer, polyester, polyurethane, polyamide, polyether, or fluorine-based or rubber-based polymer is the base polymer is used.

When using an adhesive as the junction layer 30, for example, a polyester-based adhesive, a polyurethane-based adhesive, a polyvinyl alcohol-based adhesive, or an epoxy-based adhesive is used. When the adhesive is a thermosetting adhesive, the adhesive can exhibit peeling resistance by being cured (solidified) by heating. Alternatively, when the adhesive is a light-curable adhesive such as an ultraviolet-curable type, the adhesive can exhibit peeling resistance by being cured by irradiation with light such as ultraviolet rays. Alternatively, when the adhesive is a moisture-curable adhesive that can cure by reacting with, for example, moisture in the air, the adhesive can cure and exhibit peeling resistance even by being left to stand.

### Second Example of the First Embodiment

FIG. 4 is a cross-sectional view (part 4) illustrating the switch device according to the first embodiment, and illustrates a specific second example of the configuration of the switch device. As illustrated in FIG. 4, a switch device 1B includes a glass layer 10, a junction layer 30, a switch section 60, and a support section 90.

In the switch device 1B, the thickness of the glass layer 10 is 20 μm or greater and 150 μm or less. The switch section 60 is situated on an other surface 10b side of the glass layer 10. A part or the entirety of a circumferential portion of the other surface 10b of the glass layer 10 is joined to the support section 90 via the junction layer 30. As described above, the support section 90 may be situated in a frame shape to enclose the switch section 60, or a plurality of support sections 90 may be situated at intervals at desirably selected positions that are on the outer side of the switch section 60. The junction layer 30 is provided in order to fix the in-plane position of the glass layer 10. The junction layer 30 does not need to be provided so long as the in-plane position of the glass layer 10 does not shift depending on the structure of the switch device.

The switch section 60 is a tactile switch, and includes a housing 61, a film 62, a frame 63, a stem 64, a first contact point 65, and a second contact point 66. The housing 61 and the frame 63 both have a square cup shape, and are situated to face each other via the film 62 having a tackifying property. The film 62 is situated to close the opening of the housing 61. The stem 64 is held on the frame 63 in a vertically slidable state. The first contact point 65 and the second contact point 66 are situated on the bottom surface of the housing 61. The second contact point 66 is situated above the first contact point 65 separately from the first contact point 65. The film 62 and the second contact point 66 are elastically deformable. The housing 61, the film 62, the frame 63, and the stem 64 are made of, for example, a resin.

In the switch device 1B illustrated in FIG. 4, when one surface 10a of the glass layer 10 is pushed as in the case of FIG. 2, the glass layer 10 elastically deforms, and the first contact point 65 and the second contact point 66 of the switch section 60 switch between a contacting state and a non-contacting state. FIG. 4 does not illustrate an external connection terminal to be electrically connected to the first contact point 65 and the second contact point 66.

In the example of FIG. 4, the first contact point 65 and the second contact point 66 of the switch section 60 are in a non-contacting state (non-continuous state) when the glass layer 10 is not pushed. Hence, when the glass layer 10 is pushed and deformed, the stem 64 of the switch section 60 is pushed along with this to elastically deform the film 62 and the second contact point 66, to bring the second contact point 66 close to the first contact point 65, and the first contact point 65 and the second contact point 66 contact each other and enter a continuous state. As in the case of FIG. 2, when the pushing force on the glass layer 10 is removed, the glass layer 10 returns to the state of FIG. 4, and the first contact point 65 and the second contact point 66 become a non-contacting state again.

### Third Example of the First Embodiment

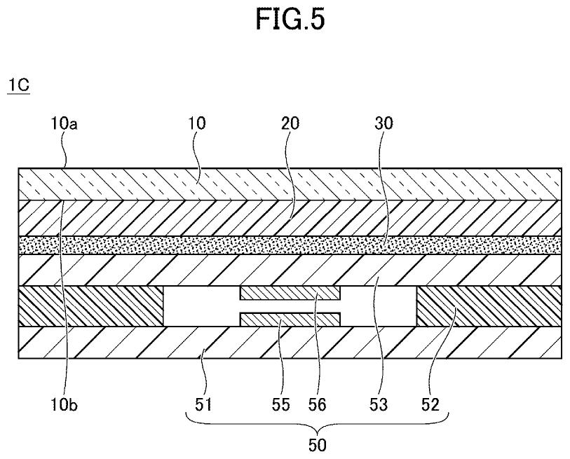

FIG. 5 is a cross-sectional view (part 5) illustrating the switch device according to the first embodiment, and illustrates a specific third example of the configuration of the switch device. As illustrated in FIG. 5, a switch device 1C is different from the switch device 1A (see FIG. 3) in that the switch device 1C includes a resin layer 20 between a glass layer 10 and a junction layer 30. That is, the resin layer 20 is interposed between the glass layer 10 and the switch section 50.

The resin layer 20 has flexibility. The thickness of the resin layer 20 is preferably 50 μm or greater and 150 μm in terms of flexibility. Examples of the material of the resin layer 20 include polyester-based resins such as polyethylene terephthalate-based resins and polyethylene naphthalate-based resins, cycloolefin-based resins such as norbornene-based resins, polyether sulfone-based resins, polycarbonate-based resins, acrylic-based resins, polyolefin-based resins, polyimide-based resins, polyamide-based resins, polyimide amide-based resins, polyallylate-based resins, polysulfone-based resins, polyether imide-based resins, and urethane-based resins.

When the glass layer 10 and the resin layer 20 are laminated in this way, the resin layer 20 has an effect of inhibiting the glass layer 10 from deforming more than necessary and inhibiting cracking of the glass layer 10, and an appropriate amount of deformation is realized. Hence, it is possible to improve durability of the glass layer 10 through repetitive elastic deformation. By varying the thickness of the resin layer 20, it is possible to control the amount of deformation of the glass layer 10.

The junction layer 30 is situated between the glass layer 10 and the resin layer 20. As the junction layer 30, a desirably selected tackifier or adhesive may be used. However, in terms of strength, it is preferable to use an adhesive as the junction layer 30. The thickness of the junction layer 30 is preferably 0.5 μm or greater and 25 μm or less, more preferably 0.5 μm or greater and 5 μm or less, and yet more preferably 0.5 μm or greater and 3 μm or less in terms of appearance.

### Fourth Example of the First Embodiment

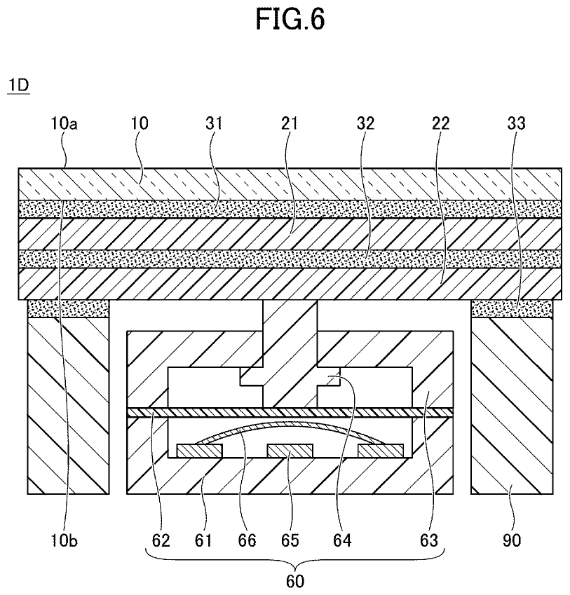

FIG. 6 is a cross-sectional view (part 6) illustrating the switch device according to the first embodiment, and illustrates a specific fourth example of the configuration of the switch device. As illustrated in FIG. 6, a switch device 1D is different from the switch device 1B (see FIG. 4) in terms of the layer configuration of the laminate joined on the support section 90.

In the switch device 1D, a junction layer 31, a resin layer 21, a junction layer 32, and a resin layer 22 are laminated sequentially on an other surface 10b of the glass layer 10. While turning the glass layer 10 outward, this laminate is joined on the support section 90 via a junction layer 33. However, the junction layer 33 is not necessarily needed so long as the laminate is fixed within the switch device 1D and does not, for example, shift in the plane.

The resin layers 21 and 22 have flexibility. The thickness of each of the resins layers 21 and 22 is preferably 50 μm or greater and 150 μm in terms of flexibility. As the material of the resin layers 21 and 22, the resin exemplified as the resin layer 20 may be used. The resin layer 21 and the resin layer 22 may be made of the same resin or different resins.

As the junction layers 31, 32, and 33, a desirably selected tackifier or adhesive may be used. However, in terms of strength, it is preferable to use an adhesive exemplified as the junction layer 30 as the junction layer 31, use a tackifier exemplified as the junction layer 30 as the junction layer 32, and use an adhesive or a tackifier exemplified as the junction layer 30 as the junction layer 33. The thickness of the junction layer 31 is preferably 0.5 μm or greater and 25 μm or less, more preferably 0.5 μm or greater and 5 μm or less, and yet more preferably 0.5 μm or greater and 3 μm or less. The thickness of the junction layer 32 is preferably 5 μm or greater and 200 μm or less, more preferably 20 μm or greater and 150 μm or less, and yet more preferably 20 μm or greater and 100 μm or less in relation with the method for producing a tackifier layer. The thickness of the junction layer 33 is preferably from 5 μm through 2 mm.

Hence, the resin layer and the junction layer each need not be a single layer, and a plurality of layers may be laminated. Such a laminate structure can inhibit cracking of the glass layer 10 and can better improve durability of the glass layer 10 through repetitive elastic deformation. This laminate structure may be applied to the switch device 1A illustrated in FIG. 5, and may be applied to the switch devices described below.

### Fifth Example of the First Embodiment

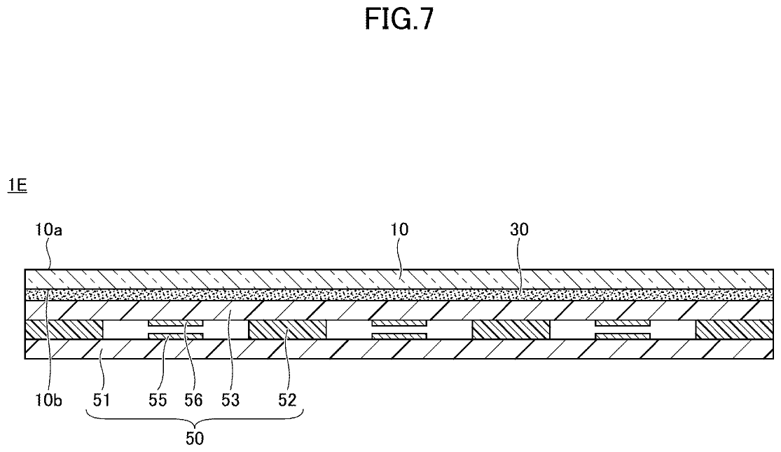

FIG. 7 is a cross-sectional view (part 7) illustrating the switch device according to the first embodiment, and illustrates a specific fifth example of the configuration of the switch device. As illustrated in FIG. 7, a switch device 1E is different from the switch device 1A (see FIG. 3) in that the switch device 1E includes a plurality of switch sections 50 on an other surface 10b side of one glass layer 10. The number of the switch sections 50 may be desirably selected. For example, the plurality of switch sections 50 may be arranged in a line, in a staggered formation, or two-dimensionally. When arranging them two-dimensionally, they may be arranged regularly (e.g., in a row-column matrix), or may be arranged irregularly.

A switch device including a plurality of switch sections in this way can be applied to various devices. Examples include a remote controller, a keyboard, a smartphone, an operation panel of a warm-water washing toilet seat, an operation panel of a home appliance, an operation panel of an audio visual device, and a wall switch.

When the switch device includes a plurality of switch sections, all the switch sections need not have the same specs. For example, as the switch sections, a membrane switch and a tactile switch may co-exist. Alternatively, some switch sections may be a non-sliding type (e.g., a capacitance type) instead of a sliding type. For example, a conceivable method is to situate a sliding-type switch section and a non-sliding-type switch section on the back surface side of one elastically-deformable glass layer that constitutes the outermost surface of, for example, a remote controller, and to use the sliding type only for a part that particularly needs to be protected from being erroneously operated, such as a power on/off switch.

### Sixth Example of the First Embodiment

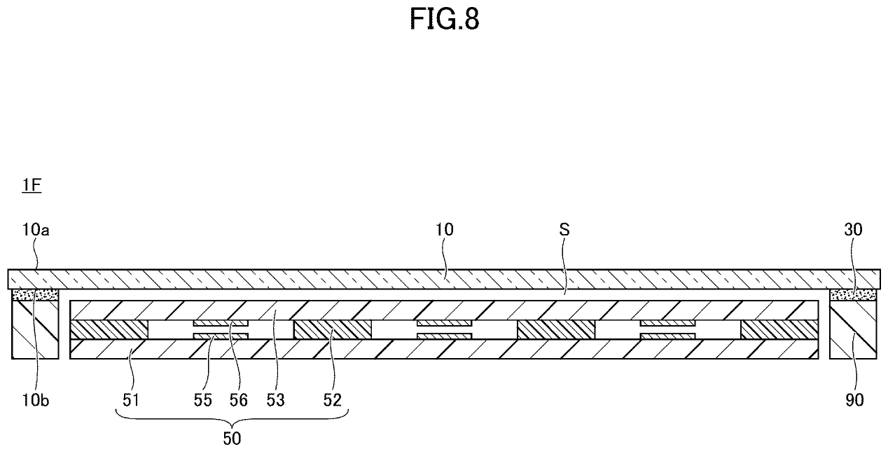

FIG. 8 is a cross-sectional view (part 8) illustrating the switch device according to the first embodiment, and illustrates a specific eighth example of the configuration of the switch device. As illustrated in FIG. 8, a switch device 1F is different from the switch device 1D (see FIG. 6) in that the switch device 1F includes a support section 90 on the outer sides of a plurality of switch sections 50 and has a space S between an other surface 10b of a glass layer 10 and the upper surface of each switch section 50.

As described, the glass layer 10 and the switch sections 50 need not necessarily contact each other, and the space S may be provided between the glass layer 10 and the switch sections 50. The existence of the space S may improve the design property depending on the purpose for which the switch device 1F is used. The same applies when a portion other than the switch sections 50 is used.

A preferable embodiment and other particulars have been described in detail above. However, the embodiment and other particulars described above are non-limiting, and various modifications and replacements are applicable to the embodiment and other particulars described above without departing from the scope described in the claims.

For example, in the embodiment described above, a membrane switch and a tactile switch are exemplified as the switch sections. However, they are non-limiting, and any types of switches may be used as the switch sections of the switch device according to the embodiment.

Decorative printing on the switch may be applied to any layer such as the glass layer and the resin layer, and may be applied to respective layers in an overlaying manner.

This international application is based on and claims priority to Japanese Patent Application No. 2021-071711, filed Apr. 21, 2021. The entire content of Japanese Patent Application No. 2021-071711 is incorporated herein by reference.

### REFERENCE SIGNS LIST

1, 1A, 1B, 1C, 1D, 1E, 1F: switch device
10: glass layer
20, 21, 22: resin layer
30, 31, 32, 33: junction layer
50, 60: switch section
51: first sheet
52: spacer
53: second sheet
55, 65: first contact point
56, 66: second contact point
61: housing
62: film
63: frame
64: stem
90: support section

1. A switch device, comprising:
a glass layer; and
a switch section situated on a back surface side of the glass layer,
wherein a thickness of the glass layer is 20 μm or greater and 150 μm or less,
the switch section includes a plurality of contact points including a vertically movable contact point, and
when the glass layer is pushed, the glass layer elastically deforms and the plurality of contact points switch between a continuous state and a non-continuous state.

2. The switch device according to claim 1, comprising:
a support section on the back surface side of the glass layer, the support section supporting the glass layer.

3. The switch device according to claim 2,
wherein the support section is constituted by part or an entirety of the switch section.

4. The switch device according to claim 2,
wherein the support section is situated on an outer side of the switch section.

5. The switch device according to claim 1, comprising:
a plurality of switch sections, each of the plurality of switch sections being the switch section.

6. The switch device according to claim 5,
wherein the switch sections are arranged two-dimensionally.

7. The switch device according to claim 1, comprising:
a junction layer interposed between the glass layer and the switch section.

8. The switch device according to claim 1, comprising:
a resin layer interposed between the glass layer and the switch section.

9. The switch device according to claim 1, comprising:
a space between the glass layer and the switch section.

10. The switch device according to claim 1,
wherein the switch section is a membrane switch.

11. The switch device according to claim 1,
wherein the switch section is a tactile switch.
